(19) United States
(12) Patent Application Publication
(10) Pub. No.: US 2025/0335915 A1
(43) Pub. Date: Oct. 30, 2025

(54) TRANSACTION EXECUTION METHODS, NODES, AND SYSTEMS IN BLOCKCHAINS

(71) Applicant: Ant Blockchain Technology (Shanghai) Co., Ltd., Shanghai (CN)

(72) Inventor: Zucheng Huang, Hangzhou (CN)

(73) Assignee: Ant Blockchain Technology (Shanghai) Co., Ltd., Shanghai (CN)

(21) Appl. No.: 19/262,250

(22) Filed: Jul. 8, 2025

Related U.S. Application Data
(63) Continuation of application No. PCT/CN2023/135009, filed on Nov. 29, 2023.

(30) Foreign Application Priority Data
Apr. 28, 2023 (CN) 202310486095.1

(51) Int. Cl. G06Q 20/40; G06Q 20/38

(52) U.S. Cl. CPC G06Q 20/401; G06Q 20/382

(57) ABSTRACT

Blockchain transaction execution is described. The blockchain includes a first node and a second node, the first node includes a trusted execution environment (TEE). The first node executes a first transaction in the TEE to obtain a first execution read-write set of the first transaction, and signs the first execution read-write set by using a private key in the TEE to obtain a first signature, where the first execution read-write set includes a first execution read set and a first execution write set. The first execution read-write set and the first signature is sent to the second node. The second node verifies the first signature by using a public key corresponding to the private key, verifies the first execution read set after the verification on the first signature succeeds, and stores the first execution write set as an execution write set of the first transaction when the verification succeeds.

### CROSS-REFERENCE TO RELATED APPLICATIONS

This application is a continuation of PCT Application No. PCT/CN2023/135009, filed on Nov. 29, 2023, which claims priority to Chinese Patent Application No. 202310486095.1, filed on Apr. 28, 2023, and each application is hereby incorporated by reference in its entirety.

### TECHNICAL FIELD

Embodiments of this specification belong to the field of blockchain technologies, and in particular, relate to transaction execution methods, nodes, and systems in blockchains.

### BACKGROUND

Blockchains are new application modes of computer technologies such as distributed data storage, point-to-point transmission, consensus mechanisms, and encryption algorithms. In blockchain systems, data blocks are organized into a chain data structure in chronological order, and distributed ledgers that cannot be tampered with or forged are cryptographically ensured. Blockchains are characterized by decentralization, information tamper-resistance, autonomy, etc., and therefore the blockchains have received increasing attention and applications.

Trusted execution environments (TEEs) can be introduced into blockchains, and the TEEs can ensure security, confidentiality, and integrity of code and data placed in the TEEs.

### SUMMARY

This application aims to provide transaction execution solutions in blockchains, to improve transaction execution efficiency in the blockchains.

A first aspect of this specification provides a transaction execution method in a blockchain. The blockchain includes a first node and a second node, the first node includes a TEE, and the method includes: the first node executes a first transaction in the TEE to obtain a first execution read-write set of the first transaction, and signs the first execution read-write set by using a private key stored in the TEE to obtain a first signature, where the first execution read-write set includes a first execution read set and a first execution write set; and sends the first execution read-write set and the first signature to the second node; and the second node verifies the first signature by using a public key corresponding to the private key, verifies the first execution read set after the verification on the first signature succeeds, and stores the first execution write set as an execution write set of the first transaction when the verification succeeds.

A second aspect of this specification provides a transaction execution method in a blockchain. The blockchain includes a first node and a second node, the first node includes a TEE, and the method is performed by the first node and includes: executing a first transaction in the TEE to obtain a first execution read-write set of the first transaction; signing the first execution read-write set by using a private key of the TEE to obtain a first signature; and sending the first execution read-write set and the first signature to the second node.

A third aspect of this specification provides a transaction execution method in a blockchain. The blockchain includes a first node and a second node, the first node includes a TEE, and the method is performed by the second node and includes: receiving, from the first node, a first execution read-write set of a first transaction and a first signature of the first execution read-write set that is generated by the TEE by using a private key stored in the TEE, where the first execution read-write set includes a first execution read set and a first execution write set; verifying the first signature by using a public key corresponding to the private key; verifying the first execution read set after the verification on the first signature succeeds; and storing the first execution write set as an execution write set of the first transaction when the verification on the first execution read set succeeds.

A fourth aspect of this specification provides a blockchain system, including a first node and a second node. The first node includes a TEE.

The first node is configured to execute a first transaction in the TEE to obtain a first execution read-write set of the first transaction, and sign the first execution read-write set by using a private key stored in the TEE to obtain a first signature, where the first execution read-write set includes a first execution read set and a first execution write set; and send the first execution read-write set and the first signature to the second node.

The second node is configured to verify the first signature by using a public key corresponding to the private key, verify the first execution read set after the verification on the first signature succeeds, and store the first execution write set as an execution write set of the first transaction when the verification succeeds.

A fifth aspect of this specification provides a first node in a blockchain. The blockchain includes a first node and a second node, the first node includes a TEE, and the first node includes: an execution unit, configured to execute a first transaction in the TEE to obtain a first execution read-write set of the first transaction, where the first execution read-write set includes a first execution read set and a first execution write set; a signing unit, configured to sign the first execution read-write set by using a private key in the TEE to obtain a first signature; and a transmission unit, configured to send the first execution read-write set and the first signature to the second node.

A sixth aspect of this specification provides a second node in a blockchain. The blockchain includes a first node and a second node, the first node includes a TEE, and the second node includes: a receiving unit, configured to receive, from the first node, a first execution read-write set of a first transaction and a first signature of the first execution read-write set that is generated by the TEE by using a private key stored in the TEE, where the first execution read-write set includes a first execution read set and a first execution write set; a verification unit, configured to verify the first signature by using a public key corresponding to the private key; and verify the first execution read set after the verification on the first signature succeeds; and a storage unit, configured to store the first execution write set as an execution write set of the first transaction when the verification on the first execution read set succeeds.

A seventh aspect of this specification provides a computer-readable storage medium, storing a computer program. A computer is enabled to perform the method according to the second aspect or the third aspect when the computer program is executed in the computer.

An eighth aspect of this specification provides a blockchain node, including a memory and a processor. The memory stores executable code, and the processor implements the method according to the second aspect or the third aspect when executing the executable code.

In embodiments of this specification, a TEE node executes a transaction in a TEE, and sends an execution read-write set of the transaction and a signature of the execution read-write set to a regular node, so that the regular node can directly accept a write set in the execution read-write set—i.e., store the write set as an execution write set of the transaction—after verification on an execution read set succeeds, without having to execute the transaction itself, thereby improving transaction execution efficiency in a blockchain.

### BRIEF DESCRIPTION OF DRAWINGS

To describe technical solutions in embodiments of this specification more clearly, the following briefly describes the accompanying drawings needed for describing embodiments. Clearly, the accompanying drawings in the following descriptions merely show some embodiments recorded in this specification, and a person of ordinary skill in the art can still derive other drawings from these accompanying drawings without creative efforts.

FIG. 1 is a diagram illustrating an architecture of a blockchain in one or more embodiments;

FIG. 2 is a schematic diagram illustrating a process in which an Admin performs TEE authentication and uploads a public key of a TEE to a blockchain in one or more embodiments of this specification;

FIG. 3 is a schematic diagram illustrating a process of executing a transaction in a TEE node in one or more embodiments of this specification;

FIG. 4 is a flowchart illustrating a transaction execution method in one or more embodiments of this specification;

FIG. 5 is a flowchart illustrating a transaction execution method in one or more other embodiments of this specification;

FIG. 6 is a diagram illustrating an architecture of a first node in a blockchain in one or more embodiments of this specification; and

FIG. 7 is a diagram illustrating an architecture of a second node in a blockchain in one or more embodiments of this specification.

### DESCRIPTION OF EMBODIMENTS

To make a person skilled in the art better understand the technical solutions in this specification, the following clearly and comprehensively describes the technical solutions in embodiments of this specification with reference to the accompanying drawings in embodiments of this specification. Clearly, the described embodiments are merely some rather than all of embodiments of this specification. All other embodiments obtained by a person of ordinary skill in the art based on embodiments of this specification without creative efforts shall fall within the protection scope of this specification.

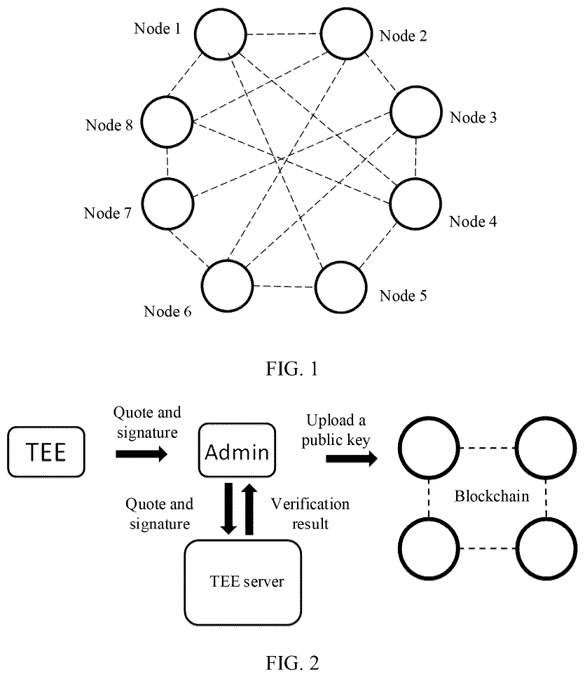

FIG. 1 is a diagram illustrating an architecture of a blockchain in one or more embodiments. In the diagram of the architecture of the blockchain in FIG. 1, blockchain 100 includes N nodes. FIG. 1 illustrates node 1 to node 8. A connection line between nodes illustrates a peer to peer (P2P) connection. The connection can be, for example, a TCP connection, and is used to transmit data between the nodes. These nodes can store a full ledger, i.e., store states of all blocks and all accounts. The nodes in the blockchain can generate the same state in the blockchain by executing the same transaction, and the nodes in the blockchain can store the same state database.

A transaction in the blockchain field can be a task unit executed in the blockchain and recorded in the blockchain. The transaction usually includes a from field, a to field, and a data field. When the transaction is a transfer transaction, the from field indicates an account address for initiating the transaction (initiating a transfer task to another account), the to field indicates an account address for receiving the transaction (receiving the transfer), and the data field includes a transfer amount.

The blockchain can provide a function of a smart contract. The smart contract in the blockchain is a contract whose execution can be triggered by a transaction in a blockchain system. The smart contract can be defined in a form of code. Calling the smart contract in the blockchain is initiating a transaction pointing to a smart contract address, so that the nodes in the blockchain run smart contract code in a distributed way.

In a contract deployment scenario, for example, Bob sends a transaction that includes information about creating a smart contract (deploying the contract) to the blockchain shown in FIG. 1, a data field of the transaction includes code (such as byte code or machine code) of the contract to be created, and a to field of the transaction is empty, to indicate that the transaction is used to deploy the contract. A contract address “0x6f8ae93 . . . ” of the contract is determined after an agreement is reached among the nodes by using a consensus mechanism. Each node adds a contract account corresponding to the contract address of the smart contract to a state database, allocates a state storage corresponding to the contract account, stores the contract code, and stores a hash value of the contract code in the state storage of the contract, so that the contract is successfully created.

In a contract calling scenario, for example, Bob sends a transaction for invoking the smart contract to the blockchain shown in FIG. 1, a from field of the transaction is an address of an account of a transaction initiator (Bob), a to field is the above-mentioned “0x6f8ae93 . . . ” namely, the address of the called smart contract, and a data field of the transaction includes a method and a parameter for calling the smart contract. After a consensus on the transaction is reached in the blockchain, the nodes in the blockchain can individually execute the transaction, to individually execute the contract, and update state databases based on the execution of the contract.

A node can be introduced into a blockchain, and the node includes a trusted execution environment (TEE). The node is referred to as a TEE node below. The TEE is a trusted execution environment that is based on secure extensions of CPU hardware and completely isolated from the outside. Currently, the industry is paying close attention to TEE solutions. Almost all mainstream chip and software alliances have their own TEE solutions, such as a trusted platform module (TPM) in a software aspect, and Software Guard Extensions (SGX), an ARM Trustzone, and an AMD platform security processor (PSP) in a hardware aspect. The TEE can function as a black box. Code and data executed in the TEE cannot be peered even at an operating system layer, and can be operated only by using an interface predefined in the code. In terms of efficiency, due to the black box nature of the TEE, plaintext data operations rather than complex cryptographic operations in homomorphic encryption are performed in the TEE, and therefore there is almost no efficiency loss in computing processes. Therefore, the use of TEE technologies can largely satisfy trusted computing needs in blockchain scenarios with relatively small performance losses.

In the TEE technologies, a software guard extensions (SGX) technology is used as an example for description. A blockchain node can create an enclave based on the SGX technology as a TEE for performing a blockchain transaction. The blockchain node can allocate a partial area, namely, an enclave page cache (EPC), in a memory by using a processor instruction newly added to a CPU, for the enclave to camp on. The memory area corresponding to the EPC is encrypted by a memory encryption engine (MEE) inside the CPU. Content (code and data in the enclave) in the memory area can be decrypted only in a CPU core, and keys for encryption and decryption are generated and stored in the CPU only when the EPC starts. It can be determined that a security boundary of the enclave includes only the enclave and the CPU. Neither privileged software nor unprivileged software can access the enclave, and even an operating system administrator or a virtual machine monitor (VMM), also referred to as a hypervisor cannot affect the code and the data in the enclave, thereby providing extremely high reliability.

After a TEE is created in a TEE node (for example, node 1 in FIG. 1) in a blockchain, specified program code can be loaded into the TEE. The following provides descriptions by using an example in which node 1 serves as a TEE node. The specified program code includes, for example, program code for executing a transfer transaction, and Ethereum virtual machine (EVM) program code for executing a contract transaction. A management server (Admin) for managing blockchain nodes can initiate a remote authentication process to the TEE, and the TEE can obtain a public-private key pair for encryption in the remote authentication process. FIG. 2 is a schematic diagram illustrating a process in which an Admin performs TEE authentication and uploads a public key of a TEE to a blockchain in one or more embodiments of this specification. The process is specifically described as follows:

Before delivery of a CPU supporting SGX, a manufacturer burns a provisioning key and a sealing key into a fuse register in the CPU. The fuse register is a one-time programming register. A fuse is blown once data is burned into the fuse register, so that content in the register can only be read but not written subsequently. The SGX manufacturer promises that the keys burned into the fuse register are randomly generated, and further promises that all backups of the burned keys are destroyed once the keys are burned, i.e., even the manufacturer does not know the burned keys. The provisioning key can represent a part of information in the CPU, for example, a code number (for example, the sixth generation Core or the seventh generation Core) and a model (for example, a desktop type or a mobile type) of the CPU. For security reasons, operations such as encryption and signing are not performed directly by using the provisioning key, but are performed by using an attestation key derived from the provisioning key. Therefore, the provisioning key plays a provisioning role.

Before the Admin initiates remote authentication to a TEE in node 1, a CPU in the blockchain node can detect whether an attestation key exists. If no attestation key exists, the CPU initiates initialization. In an initialization process, an enhanced privacy identification (EPID) can be generated through interaction with a TEE server based on a key generation protocol and according to a provisioning key generation rule. The EPID can be used as an attestation key, and is generally used as a private key sk1 in asymmetric encryption keys. The generated EPID can be stored in the TEE for subsequent signing operations. Therefore, the TEE server can obtain a public key pk1 corresponding to the EPID by using an interaction process. In particular, the public key pk1 corresponding to the EPID is not disclosed and is kept only by the TEE server. This feature is suitable for subsequent authentication by the TEE server in a remote attestation process.

After preparing the private key sk1 and the public key pk1 for remote authentication, the TEE can obtain a private key sk2 and a public key pk2 for asymmetric encryption or signature verification by using the following steps:

Step 1. The Admin initiates a challenge to the TEE in node 1 to request the TEE to present a quote, so as to verify that program code included in the TEE is correct code. Specifically, the quote is used to verify that EVM code in the TEE is correct EVM code.

Step 2. As shown in FIG. 2, after receiving the challenge, the TEE in node 1 calculates hash1 of the local code to generate a quote, where the quote includes hash1; signs the quote by using the above-mentioned key sk1 to obtain a signature sig1; and sends the quote and the signature sig1 of the quote to the Admin.

The TEE in node 1 can further obtain the public key pk2 through negotiation with the Admin by using a Diffie-Hellman key exchange (DH) algorithm or an elliptic curve Diffie-Hellman key exchange (ECDH) algorithm in step 1 and step 2. In this case, the quote can further include a hash value hash2 of the public key pk2.

Step 3. Because the Admin does not have the public key pk1 corresponding to sk1,after receiving the quote and the signature sig1 of the quote, as shown in FIG. 2, the Admin sends the quote and the signature sig1 of the quote to the TEE server.

Step 4. The TEE server verifies the signature sig1 of the quote by using the public key pk1, and returns a verification result to the Admin as shown in FIG. 2. To prevent the verification result from being intercepted or modified, the TEE server can sign the verification result by using a private key of the TEE server to obtain a signature sig2, and send the verification result and the signature sig2 of the verification result to the Admin together.

Step 5. After the Admin receives the verification result, if the verification result indicates that sig1 is correct, the Admin verifies hash1 in the quote based on a pre-obtained correct hash value of the EVM code. If the correct hash value is consistent with hash1, verification on a remote attestation succeeds, to be specific, the Admin determines that the correct EVM is running in the TEE of node 1. For example, the Admin can download the correct EVM code from an EVM official developer, and obtain the correct hash value of the EVM code through calculation based on the correct EVM code.

Step 6. The Admin generates the private key sk2 corresponding to the public key pk2, performs symmetric encryption on the private key sk2 by using the public key pk2, and sends a ciphertext private key to the TEE of node 1.

Step 7. After receiving the ciphertext private key, the TEE of node 1 can decrypt the ciphertext private key by using the public key pk2 to obtain the private key sk2, and store the private key sk2 and the public key pk2 in the TEE together.

After sending the private key sk2 to the TEE of node 1, the Admin can send a transaction Tx1 for calling a system contract to the blockchain, to upload node information of node 1 to the blockchain, so as to add node 1 to the blockchain. The node information includes a public key (the public key pk2) of the TEE of node 1. The system contract is pre-deployed in the blockchain, and the system contract is used to manage nodes in the blockchain, for example, add a node to the blockchain or delete a node from the blockchain. The Admin can send a transaction for calling the system contract to the blockchain, to manage the nodes in the blockchain. For the TEE node, in addition to general attributes (such a node identifier and an IP address) of the node, the transaction Tx1 further includes the public key of the TEE, to upload the public key of the TEE to the blockchain. As such, another node in the blockchain can query a contract state of the system contract to query the public key of the TEE of node 1, and therefore can verify a signature of the TEE by using the public key of the TEE. In one or more implementations, the transaction Tx1 can further include the above-mentioned quote, signature of the quote, signature verification result of the TEE server, and the signature of the TEE server on the verification result, so that another node in the blockchain can verify the TEE in node 1 based on the information after the information is uploaded to the blockchain.

It can be understood that the TEE in the TEE node in the blockchain is not limited to obtaining the public-private key pair (sk2 and pk2) for asymmetric encryption or signature verification in the above-mentioned way, but can obtain the public-private key pair for asymmetric encryption in any known secure way.

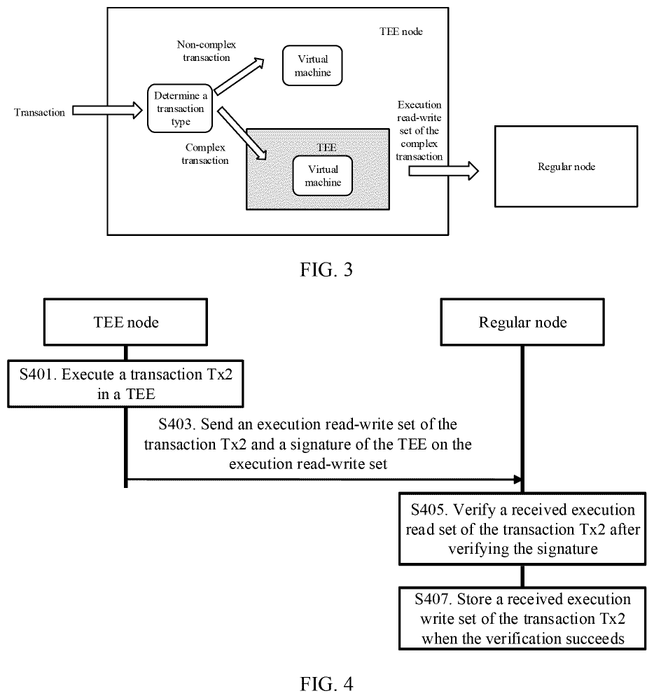

FIG. 3 is a schematic diagram illustrating a process of executing a transaction in a TEE node in one or more embodiments of this specification. As shown in FIG. 3, the TEE node includes a virtual machine outside a TEE and a virtual machine inside the TEE. For a blockchain including a TEE node, a field field1 used to indicate a transaction type is set for a transaction in the embodiments of this specification. For example, the field is used to indicate whether the transaction is a complex transaction or a non-complex transaction. As shown in FIG. 3, when executing a transaction, the TEE node first determines, based on a field value of a field field1 in the transaction, whether the transaction is a complex transaction. If the TEE node determines that the transaction is a non-complex transaction, the TEE node executes the transaction by using the virtual machine outside the TEE. If the TEE node determines that the transaction is a complex transaction, the TEE node executes the transaction by using the virtual machine inside the TEE to obtain an execution read-write set of the transaction. Then, the TEE can sign the execution read-write set, and send the execution read-write set and a signature of the execution read-write set to a regular node, so that the regular node can directly accept a write set in the execution read-write set—i.e., store the write set as an execution write set of the transaction Tx2—after verification on the execution read-write set succeeds, without having to execute the complex transaction Tx2 itself, thereby improving transaction execution efficiency in the blockchain. The regular node can be a node that does not include a TEE. It can be understood that, although the embodiments of this specification provide descriptions by using the complex transaction as an example, the embodiments of this specification are not limited to executing the complex transaction in the TEE. For example, the TEE node can execute each transaction in a block in the TEE, or the TEE node can execute a transaction of a specific type in the TEE, for example, a transaction for calling a specific contract. Implementations are not limited.

FIG. 4 is a flowchart illustrating a transaction execution method in one or more embodiments of this specification. The method can be performed by a TEE node and a regular node in a blockchain.

As shown in FIG. 4, in step S401, the TEE node performs a complex transaction Tx2 in a TEE.

For example, node 1 in the blockchain is a TEE node, and other nodes are regular nodes that do not include TEEs. As shown in FIG. 3, when executing, for example, a transaction Tx2, node 1 first determines whether the transaction Tx2 is a complex transaction. If the transaction is a complex transaction, node 1 executes the transaction Tx2 in a TEE. Specifically, the transaction Tx2 includes the above-mentioned field field1. Node 1 can first read a value of the field field1 in the transaction Tx2, and determine, based on the value, that the transaction Tx2 is a complex transaction.

In the TEE of node 1, the transaction Tx2 can be executed in a virtual machine to obtain an execution result and an execution read-write set of the transaction Tx2. The execution result is a transaction receipt returned to a user. The execution read-write set includes an execution read set and an execution write set, the execution read set includes a key-value pair of a variable read during execution of the transaction Tx2, and the execution write set includes a key-value pair of a variable written during execution of the transaction Tx2.

Before executing the transaction Tx2, node 1 can perform read-write set analysis on the transaction Tx2 to obtain an analysis read-write set of the transaction Tx2. The analysis read-write set includes an analysis read set and an analysis write set. The analysis read set includes an identifier that is of an object to be read during execution of the transaction Tx2 and that is obtained through analysis, and a key that is of a variable to be written during execution of the transaction Tx2 and that is obtained through analysis.

When the transaction Tx2 is used to call a contract, variables accessed during execution of the transaction Tx2 may include the following three variables:

In a first case, a state variable A accessed in the contract is a fixed-length variable, and a key of the variable A in a state database can be determined based on, for example, a declaration location of the variable A in the contract. Therefore, the key of the variable A to be accessed can be determined before execution of the transaction Tx2. For the state variable A accessed in the contract, when read-write set analysis is performed on the transaction Tx2, the key of the state variable A can be obtained through analysis, and the key of the state variable A can be recorded in the analysis read-write set.

In a second case, a state variable (for example, a variable B) accessed in the contract is a state variable corresponding to a mapping relationship. Based on the mapping relationship, the variable B is mapped to information in a transaction body of a transaction (for example, a transaction Tx2) for calling the contract Contract1, and a key of the variable B in a state database can be determined based on an identifier of the mapping relationship and the information in the transaction Tx2. Therefore, the key of the variable B to be accessed can be determined before execution of the transaction Tx2. The mapping relationship is associated with a sending account of the transaction, an incoming parameter of the transaction for the contract, etc. For example, the contract includes a mapping relationship a[ ], and the mapping relationship is used to map a sending account of a transaction for calling the contract to a state variable a [from]. In this case, the state variable a [from] can be determined based on a declaration location of the mapping relationship a[ ] in the contract and a value of a from field in the transaction Tx2. For the state variable B accessed in the contract, when read-write set analysis is performed on the transaction Tx2, the key of the state variable B can be obtained through analysis, and the key of the state variable B can be recorded in the analysis read-write set.

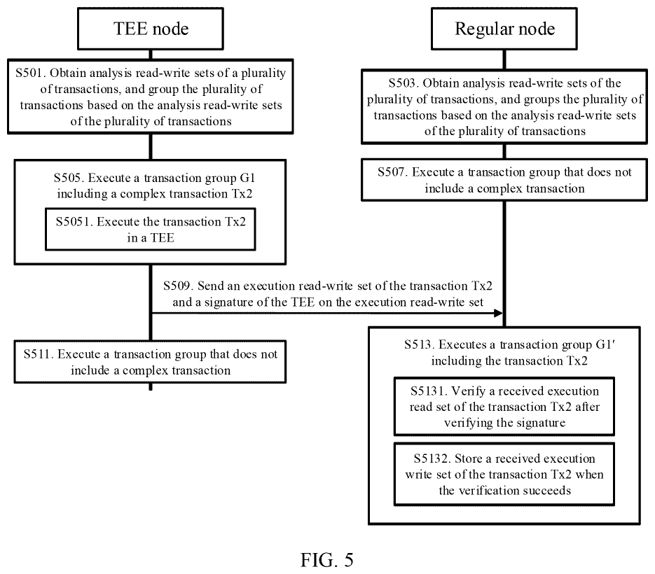

In a third case, a state variable accessed in the contract is a state variable corresponding to a mapping relationship, the mapping relationship is associated with a value of a state variable C declared in the contract, and the value of the state variable C needs to be read from a state database. For example, the contract Contract1 includes a mapping relationship e[ ], and the mapping relationship is used to map the state variable C to a state variable e [C]. Because the value of the state variable C cannot be determined before execution of the transaction Tx2, a key of the variable e[C] cannot be determined before execution of the transaction Tx2. For the state variable e[C], when read-write set analysis is performed on the transaction Tx2, an identifier of the mapping relationship e[ ] can be recorded in the analysis read-write set. Instead of the key of the variable e[C], the identifier of the mapping relationship e[ ] is recorded in the analysis read-write set, so that a plurality of transactions can be grouped based on the analysis read-write set. The grouping of the plurality of transactions is described in detail below with reference to FIG. 5.

Assume that the above-mentioned state variables A, B, and e [C] are variables read in the contract. Before executing the transaction Tx, node 1 can first read values corresponding to keys of the state variables in the analysis read set based on the above-obtained analysis read-write set, where the values can specifically include the values of the state variables A and B; and provide the transaction Tx2, the analysis read-write set, and the values of the keys in the analysis read set for the TEE together. The TEE can supplement pre-read values of the state variables to the analysis read set, perform the transaction Tx2 based on the pre-read values of the state variables to obtain written values of the state variables, and supplement the written values of the state variables to the analysis write set. In addition, for the above-mentioned state variable e[C], the TEE can read the value of the state variable C, determine a key of the state variable e[C] based on the value of the state variable and the identifier of the mapping relationship e[ ], read a value of the state variable e[C] based on the key, supplement the key-value pair to the analysis read set, and delete the identifier that is of the mapping relationship e[ ] and that is previously recorded in the analysis read set. The analysis read-write set is modified as such, so that the execution read-write set of the transaction Tx2 can be obtained. To be specific, the execution read set of the transaction Tx2 can include key-value pairs of the state variables A, B, and e[C].

After obtaining the execution read-write set of the transaction Tx2, the TEE in node 1 can sign the execution read-write set by using a private key (for example, the above-mentioned private key sk2) pre-stored in the TEE, to send the execution read-write set to a regular node. In one or more implementations, the TEE in node 1 can sign the execution result and the execution read-write set by using the private key sk2, to send the execution result and the execution read-write set to the regular node.

In step S403, the TEE node sends an execution read-write set of the transaction Tx2 and a signature of the TEE on the execution read-write set to the regular node.

The TEE node can send the execution read-write set of the transaction Tx2 and the signature of the TEE on the execution read-write set to each regular node in the blockchain, so that each regular node does not need to execute the complex transaction. In one or more implementations, the TEE node can send the execution read-write set of the transaction Tx2, a transaction receipt, and signatures of the TEE on the execution read-write set and the transaction receipt to each regular node in the blockchain.

The following provides descriptions by using node 2 as a regular node. It can be understood that other regular nodes in the blockchain can operate similarly to node 2.

In step S405, the regular node verifies the signature, and verifies the received execution read set of the transaction Tx2 after verifying the signature.

Node 2 can pre-query a public key (for example, pk2) of the TEE in node 1 from a contract state of the system contract. When executing the transaction Tx2, node 2 first determines, based on the field field1 in the transaction Tx2, that the transaction Tx2 is a complex transaction. Then, node 2 determines whether the execution read-write set of the transaction Tx2 and the signature are received from node 1. If the execution read-write set of the transaction Tx2 and the signature are not received, node 2 waits. When having not received the execution read-write set of the transaction Tx2 and the signature after waiting for predetermined time, node 2 can continue to normally execute the transaction Tx2.

After receiving the execution read-write set of the transaction Tx2 and the signature from node 1 within the predetermined time, node 2 can verify the received signature of the TEE by using the public key pk2. When the signature is verified, node 2 can determine that the received execution read-write set of the transaction Tx2 is indeed the execution read-write set generated by the TEE by executing the transaction Tx2.

After the verification on the signature succeeds, node 2 can verify the received execution read set of the transaction Tx2.

Node 2 can perform read-write analysis on the transaction Tx2 similarly to node 1, to obtain an analysis read-write set of the transaction Tx2. The analysis read-write set includes, for example, the keys of the state variables A and B and the identifier of the mapping relationship e[ ]. When determining that the received execution read set includes the keys of the state variables A and B and the identifier of the mapping relationship e[ ], node 2 reads current values of the state variables A and B, and determines whether the values of the state variables A and B in the execution read set are consistent with the read current values of the state variables A and B. If the values of the state variables A and B in the execution read set are consistent with the read current values of the state variables A and B, verification on the state variables A and B succeeds.

Then, node 2 can determine that the state variable e[C] is a state variable that needs to be read and that is determined by the TEE during execution of the transaction Tx2. Therefore, node 2 can trust the key of the state variable e[C], read a current value of the state variable e[C], and determine whether the value of the state variable e[C] in the execution read set is consistent with the read current value of the state variable e[C]. If the value of the state variable e[C] in the execution read set is consistent with the read current value of the state variable e[C], verification on the state variable e[C] succeeds.

If node 2 determines that the execution read set includes neither the keys of the state variables A and B nor the identifier of the mapping relationship e[ ], determines that the values of the state variables A and B in the execution read set are inconsistent with the read current values of the state variables A and B, or determines that the value of the state variable e[C] in the execution read set is inconsistent with the read current value of the state variable e[C], node 2 can determine that verification on the execution read set of the transaction Tx2 fails. Node 2 can continue to normally execute the transaction Tx2 if the verification on the execution read set of the transaction Tx2 fails.

In step S407, node 2 stores the received execution write set of the transaction Tx2 when the verification succeeds.

After the above-mentioned verification succeeds, node 2 can determine that the execution write set that is of the transaction Tx2 and that is received from node 1 is a correct write set, and therefore can store the received execution write set as an execution write set of the transaction Tx2, without having to execute the transaction Tx2 itself.

According to the transaction execution solution, the regular node does not need to execute the complex transaction, thereby saving computing resources in the blockchain and improving transaction execution efficiency in the blockchain.

FIG. 5 is a flowchart illustrating a transaction execution method in one or more other embodiments of this specification.

As shown in FIG. 5, first, in step S501, a TEE node obtains analysis read-write sets of a plurality of transactions, and groups the plurality of transactions based on the analysis read-write sets of the plurality of transactions.

The TEE node can analyze data corresponding to the transactions to determine the analysis read-write sets of the transactions. In one or more implementations, when a contract is deployed, information about storage locations of state variables read and written in the contract can be stored in a contract state of the contract together with contract code, so that the TEE node can read the information about the storage locations of the state variables read and written in the contract from a blockchain, and obtain the analysis read-write sets of the transactions based on the read information.

Then, the TEE node can determine an access conflict between the transactions based on the analysis read-write sets of the transactions, to group the plurality of transactions, so that multiple transactions having an access conflict are placed in one transaction group, and no access conflict exists between different transaction groups. Specifically, a plurality of transactions corresponding to any one of the following cases can be determined as having an access conflict: Analysis write sets of the plurality of transactions include the same key; and an analysis write set of one of the plurality of transactions includes the same key as an analysis read set of another transaction.

After grouping the plurality of transactions, the TEE node obtains, for example, four transaction groups G1, G2, G3, and G4. Assume that the transaction group G1 includes the above-mentioned complex transaction Tx2, and the transaction groups G2 to G4 do not include a complex transaction.

In step S503, a regular node obtains analysis read-write sets of the plurality of transactions, and groups the plurality of transactions based on the analysis read-write sets of the plurality of transactions.

For this step, references can be made to the above descriptions of step S501. The regular node can obtain the analysis read-write sets of the transactions in the same way as the TEE node, and group the plurality of transactions to obtain transaction groups G1′, G2′, G3′, and G4′. Assume that the transaction group G1′ includes the above-mentioned complex transaction Tx2, and the transaction groups G2′ to G4′ do not include a complex transaction. When the TEE node does not do evil, the transaction groups G1′, G2′, G3′, and G4′ should be the same as the transaction groups G1, G2, G3, and G4.

In step S505, the TEE node executes the transaction group G1 including the complex transaction Tx2.

The TEE node preferentially schedules the transaction group G1 after determining that the transaction group G1 includes the complex transaction. For example, if the TEE node includes two threads for executing transactions, the two threads first execute the transaction group G1 and any transaction group (for example, the transaction group G4) in the transaction groups G2 to G4. During execution of step S505, the TEE node performs step S5051. Execute the transaction Tx2 in a TEE. For this step, references can be made to the above descriptions of step S401. Details are omitted here for simplicity.

In step S507, the regular node executes a transaction group that does not include a complex transaction.

Node 2 is used as an example. Node 2 can preferentially execute a transaction group that does not include a complex transaction, thereby minimizing cases of waiting for the TEE node to execute the complex transaction. Specifically, if node 2 includes two threads for executing transactions, node 2 can first execute, for example, transaction groups G2′ and G3′, in parallel, and starts execution of the transaction groups G′ and G4′ after completing execution of the transaction groups G2′ and G3′.

In step S509, the TEE node sends an execution read-write set of the transaction Tx2 and a signature of the TEE on the read-write set to the regular node.

For this step, references can be made to the above descriptions of step $403. Details are omitted here for simplicity.

In step S511, the TEE node executes a transaction group that does not include a complex transaction.

After executing the transaction groups G1 and G4 in parallel, the TEE node can continue to execute the transaction groups G2 and G3 in parallel.

In step S513, the regular node executes the transaction group G1′ including the transaction Tx2.

For example, node 2 executes the transaction groups G1′ and G4′ in parallel after completing execution of the transaction groups G2′ and G3′. When executing the transaction Tx2, node 2 performs step S5131 and step S5132 when determining that the execution read-write set of the transaction Tx2 and the signature are received from the TEE node, and therefore can directly accept the execution write set that is of the transaction Tx2 and that is sent by node 1, without having to execute the transaction Tx2 itself. In addition, because node 2 schedules the transaction group G1′, it is ensured that node 2 has received the execution read-write set of the transaction Tx2 and the signature when executing the transaction Tx2, thereby reducing waiting time of node 2. For step S5131 and step S5132, references can be made to the above descriptions of step S405 and step S407. Details are omitted here for simplicity.

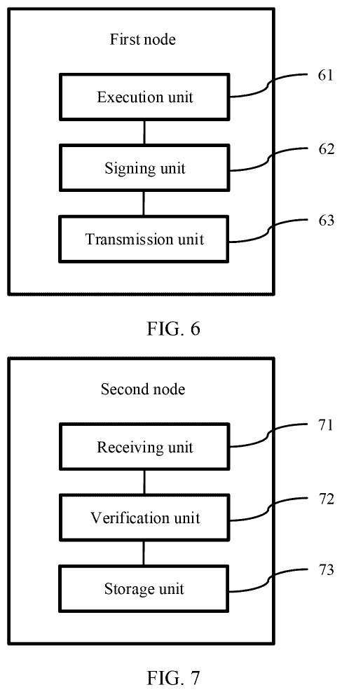

FIG. 6 is a diagram illustrating an architecture of a first node in a blockchain in one or more embodiments of this specification. The blockchain includes the first node and a second node, the first node includes a TEE, and the first node is configured to perform the method shown in FIG. 4 or FIG. 5 and includes: execution unit 61, configured to execute a first transaction in the TEE to obtain a first execution read-write set of the first transaction, where the first execution read-write set includes a first execution read set and a first execution write set; signing unit 62, configured to sign the first execution read-write set by using a private key stored in the TEE to obtain a first signature; and transmission unit 63, configured to send the first execution read-write set and the first signature to the second node.

FIG. 7 is a diagram illustrating an architecture of a second node in a blockchain in one or more embodiments of this specification. The blockchain includes a first node and the second node, the first node includes a TEE, and the second node is configured to perform the method shown in FIG. 4 or FIG. 5 and includes: receiving unit 71, configured to receive, from the first node, a first execution read-write set of a first transaction and a first signature of the first execution read-write set that is generated by the TEE by using a private key stored in the TEE, where the first execution read-write set includes a first execution read set and a first execution write set; verification unit 72, configured to verify the first signature by using a public key corresponding to the private key; and verify the first execution read set after the verification on the first signature succeeds; and storage unit 73, configured to store the first execution write set as an execution write set of the first transaction when the verification on the first execution read set succeeds.

One or more embodiments of this specification further provide a computer-readable storage medium, storing a computer program. A computer is enabled to perform the method shown in FIG. 4 or FIG. 5 when the computer program is executed in the computer.

One or more embodiments of this specification further provide a blockchain node, including a memory and a processor. The memory stores executable code, and the processor implements the method shown in FIG. 4 or FIG. 5 when executing the executable code.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure to a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer independently performs programming to “integrate” a digital system onto a PLD, without requesting a chip manufacturer to design and manufacture a dedicated integrated circuit chip. Moreover, nowadays, instead of manually making an integrated circuit chip, this programming is mostly implemented by “logic compiler” software. The software is similar to a software compiler used when the program is developed and written, and original code existing before compilation also has to be written in a specific programming language. The language is referred to as Hardware Description Language (HDL). There is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. A person skilled in the art should also be clear that a hardware circuit that implements a logical method procedure can be readily obtained once the method procedure is logically programmed by using multiple of the above-mentioned hardware description languages and is programmed to an integrated circuit.

A controller can be implemented in any appropriate way. For example, the controller can be in a form of a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microcontroller. Examples of the controller include but are not limited to the following microcontrollers: ARC 625D, Atmel AT91SAM, Microchip PIC18F26K20, and Silicone Labs C8051F320. A memory controller can be further implemented as a part of control logic of a memory. A person skilled in the art also knows that in addition to implementing the controller by using only the computer-readable program code, method steps can be logically programmed to enable the controller to implement the same function in a form of a logic gate, a switch, an application-specific integrated circuit, a programmable logic controller, an embedded microcontroller, etc. Therefore, the controller can be considered as a hardware component, and an apparatus that is configured to implement various functions and that is included in the controller can also be considered as a structure in the hardware component. Alternatively, the apparatus configured to implement various functions can even be considered as both a software module implementing a method and a structure in the hardware component.

The systems, apparatuses, modules, or units described in the above-mentioned embodiments can be specifically implemented by a computer chip or an entity, or can be implemented by a product having a certain function. A typical implementing device is a server system. Certainly, this application does not exclude that with the development of computer technologies in the future, the computer that implements the functions of the above-mentioned embodiments can be, for example, a personal computer, a laptop computer, a vehicular human-computer interaction device, a cellular phone, a camera phone, a smart phone, a personal digital assistant, a media player, a navigation device, an email device, a game console, a tablet computer, a wearable device, or a combination of any of these devices. Although one or more embodiments of this specification provide method operation steps as described in embodiments or flowcharts, more or fewer operation steps can be included on the basis of conventional or noncreative means. The sequence of the steps enumerated in the embodiments is only one way among a plurality of step execution sequences and does not represent a unique execution sequence. When being executed in an actual apparatus or terminal product, the steps can be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a series of elements includes not only those elements but also other elements not explicitly listed, or elements inherent to such a process, method, product, or device. Without further limitations, it does not preclude the existence of additional identical or equivalent elements in the process, method, product, or device including such elements. For example, if the words such as first and second are used to represent names, they do not indicate any particular order.

For ease of description, when the above-mentioned apparatus is described, the apparatus is divided into various modules based on functions for separate descriptions. Certainly, when one or more embodiments of this specification are implemented, functions of the modules can be implemented in one or more pieces of software and/or hardware, or modules that implement the same function can be implemented by a combination of a plurality of sub-modules or sub-units. The apparatus embodiments described above are merely examples. For example, the division into the units is merely a logical function division. In actual implementations, there can be other ways of division. For example, a plurality of units or components can be combined or can be integrated into another system, or some features can be omitted, or not performed. In addition, the displayed or discussed mutual couplings or direct couplings or communication connections may be implemented through some interfaces. The indirect couplings or communication connections between the apparatuses or the units may be implemented in electronic, mechanical, or other forms.

This application is described with reference to the flowcharts and/or block diagrams of the method, the apparatus (system), and the computer program product according to embodiments of this application. It is worthwhile to understand that each procedure and/or each block in the flowcharts and/or the block diagrams and a combination of procedures and/or a combination of blocks in the flowcharts and/or block diagrams can be implemented by using computer program instructions. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

Alternatively, these computer program instructions can be stored in a computer-readable storage that can instruct the computer or the another programmable data processing device to work in a specific way, so that the instructions stored in the computer-readable storage generate an artifact that includes an instruction apparatus. The instruction apparatus implements a specified function in one or more procedures in the flowcharts and/or in one or more blocks in the block diagrams.

Alternatively, these computer program instructions can be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specified function in one or more procedures in the flowcharts and/or in one or more blocks in the block diagrams.

In a typical configuration, a computing device includes one or more processors (CPUs), an input/output interface, a network interface, and a memory. The memory may include a volatile memory, a random access memory (RAM), a nonvolatile memory, and/or other forms in computer-readable media, such as a read-only memory (ROM) or a flash memory (flash RAM). The memory is an example of the computer-readable medium.

The computer-readable medium includes persistent, non-persistent, movable, and unmovable media that can store information by using any method or technology. The information can be a computer-readable instruction, a data structure, a program module, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage or another magnetic storage device, or any other non-transmission medium. The computer storage medium can be configured to store information accessible to a computing device. As described in this specification, the computer-readable medium does not include computer-readable transitory media such as a modulated data signal and a carrier.

A person skilled in the art should understand that one or more embodiments of this specification can be provided as methods, systems, or computer program products. Therefore, the one or more embodiments of this specification can be in a form of hardware only embodiments, software only embodiments, or embodiments with a combination of software and hardware. In addition, the one or more embodiments of this specification can be in a form of a computer program product implemented on one or more computer-usable storage media (including but not limited to a magnetic disk memory, a CD-ROM, an optical memory, etc.) that include computer-usable program code.

The one or more embodiments of this specification can be described in the general context of computer executable instructions executed by a computer, for example, a program module. Generally, the program module includes a routine, a program, an object, a component, a data structure, etc. executing a specific task or implementing a specific abstract data type. The one or more embodiments of this specification can alternatively be practiced in distributed computing environments. In the distributed computing environments, tasks are performed by remote processing devices connected through a communication network. In a distributed computing environment, the program module can be located in both local and remote computer storage media including storage devices.

Embodiments of this specification are described in a progressive way. For same or similar parts in embodiments, references can be made to each other. Each embodiment focuses on a difference from another embodiment. Especially, a system embodiment is basically similar to a method embodiment, and therefore is described briefly. For a related part, references can be made to some descriptions in the method embodiment. In the description of this specification, descriptions about reference terms such as “an embodiment”, “some embodiments”, “an example”, “a specific example”, and “some examples” mean that specific features, structures, materials, or characteristics described with reference to the embodiment or example are included in at least one embodiment or example of this specification. In this specification, the schematic expressions of the above-mentioned terms are not necessarily directed to the same embodiment or example. Moreover, the described specific features, structures, materials, or characteristics can be combined in any one or more embodiments or examples in a suitable way. In addition, without contradicting each other, a person skilled in the art can combine and integrate different embodiments or examples described in this specification and features of the different embodiments or examples.

The above descriptions are merely one or more embodiments of this specification, and are not intended to limit the one or more embodiments of this specification. A person skilled in the art can make various modifications and changes to one or more embodiments of this specification. Any modifications, equivalent replacements, improvements, etc. made without departing from the spirit and principle of this specification shall fall within the scope of the claims.

What is claimed is:

1. A computer-implemented method for blockchain transaction execution, comprising:
executing, by a first node of a blockchain, a first transaction in a trusted execution environment (TEE) of the first node to obtain a first execution read-write set of the first transaction;
signing the first execution read-write set by using a private key stored in the TEE to obtain a first signature, wherein the first execution read-write set comprises a first execution read set and a first execution write set;
sending the first execution read-write set and the first signature to a second node of the blockchain;
verifying, by the second node, the first signature by using a public key corresponding to the private key;
verifying the first execution read set after the verification on the first signature succeeds; and
storing the first execution write set as an execution write set of the first transaction when the verification succeeds.

2. The computer-implemented method of claim 1, wherein verifying the first execution read set, comprises:
performing, by the second node, read-write set analysis on the first transaction to obtain a second analysis read set of the first transaction, wherein the second analysis read set of the first transaction comprises keys of multiple first variables;
reading first values of the multiple first variables when determining that the first execution read set comprises the keys of multiple first variables; and
determining whether the first values are consistent with values of the multiple first variables in the first execution read set, wherein the verification on the first execution read set fails if the first values are inconsistent with the values of the multiple first variables in the first execution read set.

3. The computer-implemented method of claim 2, wherein:
the first execution read set comprises key-value pairs of multiple second variables; and
verifying the first execution read set, comprises:
reading second values of the multiple second variables; and
determining whether the second values are consistent with values of the multiple second variables in the first execution read set, wherein the verification on the first execution read set fails if the second values are inconsistent with the values of the multiple second variables in the first execution read set.

4. The computer-implemented method of claim 2, wherein:
the first transaction is a transaction of a predetermined type, and comprising:
individually performing, by the first node, read-write set analysis on a plurality of transactions to obtain respective first analysis read-write sets of the plurality of transactions;
grouping the plurality of transactions based on the plurality of transactions based on a plurality of first analysis read-write sets to obtain a plurality of transaction groups, wherein the plurality of transaction groups comprise a first transaction group and a second transaction group, the first transaction group comprises the first transaction, and the second transaction group does not comprise a transaction of the predetermined type; and
executing, by the first node, a first transaction in the TEE, comprises:
executing, by the first node, transactions in the first transaction group before executing transactions in the second transaction group.

5. The computer-implemented method of claim 4, wherein:
each transaction comprises a first field used to indicate whether the transaction is a transaction of the predetermined type; and
executing, by the first node, a first transaction in the TEE, comprises:
determining, by the first node based on a first field of the first transaction, that the first transaction is a transaction of the predetermined type, providing the first transaction for the TEE, and executing the first transaction in the TEE.

6. The computer-implemented method of claim 5, wherein performing, by the second node, read-write set analysis on the first transaction, comprises:
individually performing, by the second node, read-write set analysis on the plurality of transactions to obtain respective second analysis read-write sets of the plurality of transactions; and
comprising:
grouping, by the second node, the plurality of transactions based on a plurality of second analysis read-write sets to obtain a plurality of transaction groups, wherein the plurality of transaction groups comprise a third transaction group and a fourth transaction group, wherein the third transaction group comprises the first transaction, and wherein the fourth transaction group does not comprise a transaction of the predetermined type; and
executing, by the second node, transactions in the fourth transaction group before executing transactions in the third transaction group.

7. The computer-implemented method of claim 6, comprising:
when executing the first transaction in the third transaction group, after determining, based on the first field of the first transaction, that the first transaction is a transaction of the predetermined type:
determining, by the second node, whether the first execution read-write set of the first transaction and the first signature are received from the first node; and
waiting when determining that the first execution read-write set and the first signature are not received from the first node.

8. The computer-implemented method of claim 7, wherein the second node executes the first transaction when waiting timeout occurs or when verification on the first execution read set fails.

9. The computer-implemented method of claim 1, wherein:
a system contract is deployed in the blockchain, a contract state of the system contract stores the public key; and
comprising:
querying, by the second node, the contract state of the system contract to obtain the public key.

10. The computer-implemented method of claim 1, wherein executing, by the first node, a first transaction in the TEE to obtain a first execution read-write set of the first transaction, signing the first execution read-write set by using a private key stored in the TEE to obtain a first signature; and sending the first execution read-write set and the first signature to the second node, comprises:
executing, by the first node, the first transaction in the TEE to obtain the first execution read-write set and a transaction receipt of the first transaction;
signing the first execution read-write set and the transaction receipt by using the private key stored in the TEE to obtain the first signature; and
sending the first execution read-write set, the transaction receipt, and the first signature to the second node.

11. A non-transitory, computer-readable medium storing one or more instructions executable by a computer system to perform one or more operations for blockchain transaction execution, comprising:
executing, by a first node of a blockchain, a first transaction in a trusted execution environment (TEE) of the first node to obtain a first execution read-write set of the first transaction;
signing the first execution read-write set by using a private key stored in the TEE to obtain a first signature, wherein the first execution read-write set comprises a first execution read set and a first execution write set;
sending the first execution read-write set and the first signature to a second node of the blockchain;
verifying, by the second node, the first signature by using a public key corresponding to the private key;
verifying the first execution read set after the verification on the first signature succeeds; and
storing the first execution write set as an execution write set of the first transaction when the verification succeeds.

12. The non-transitory, computer-readable medium of claim 11, wherein verifying the first execution read set, comprises:
performing, by the second node, read-write set analysis on the first transaction to obtain a second analysis read set of the first transaction, wherein the second analysis read set of the first transaction comprises keys of multiple first variables;
reading first values of the multiple first variables when determining that the first execution read set comprises the keys of multiple first variables; and
determining whether the first values are consistent with values of the multiple first variables in the first execution read set, wherein the verification on the first execution read set fails if the first values are inconsistent with the values of the multiple first variables in the first execution read set.

13. The non-transitory, computer-readable medium of claim 12, wherein:
the first execution read set comprises key-value pairs of multiple second variables; and
verifying the first execution read set, comprises:
reading second values of the multiple second variables; and
determining whether the second values are consistent with values of the multiple second variables in the first execution read set, wherein the verification on the first execution read set fails if the second values are inconsistent with the values of the multiple second variables in the first execution read set.

14. The non-transitory, computer-readable medium of claim 12, wherein:
the first transaction is a transaction of a predetermined type, and
comprising:
individually performing, by the first node, read-write set analysis on a plurality of transactions to obtain respective first analysis read-write sets of the plurality of transactions;
grouping the plurality of transactions based on the plurality of transactions based on a plurality of first analysis read-write sets to obtain a plurality of transaction groups, wherein the plurality of transaction groups comprise a first transaction group and a second transaction group, the first transaction group comprises the first transaction, and the second transaction group does not comprise a transaction of the predetermined type; and
executing, by the first node, a first transaction in the TEE, comprises:
executing, by the first node, transactions in the first transaction group before executing transactions in the second transaction group.

15. The non-transitory, computer-readable medium of claim 14, wherein:
each transaction comprises a first field used to indicate whether the transaction is a transaction of the predetermined type; and
executing, by the first node, a first transaction in the TEE, comprises:
determining, by the first node based on a first field of the first transaction, that the first transaction is a transaction of the predetermined type, providing the first transaction for the TEE, and executing the first transaction in the TEE.

16. The non-transitory, computer-readable medium of claim 15, wherein performing, by the second node, read-write set analysis on the first transaction, comprises:
individually performing, by the second node, read-write set analysis on the plurality of transactions to obtain respective second analysis read-write sets of the plurality of transactions; and
comprising:
grouping, by the second node, the plurality of transactions based on a plurality of second analysis read-write sets to obtain a plurality of transaction groups, wherein the plurality of transaction groups comprise a third transaction group and a fourth transaction group, wherein the third transaction group comprises the first transaction, and wherein the fourth transaction group does not comprise a transaction of the predetermined type; and
executing, by the second node, transactions in the fourth transaction group before executing transactions in the third transaction group.

17. The non-transitory, computer-readable medium of claim 16, comprising:
when executing the first transaction in the third transaction group, after determining, based on the first field of the first transaction, that the first transaction is a transaction of the predetermined type:
determining, by the second node, whether the first execution read-write set of the first transaction and the first signature are received from the first node; and
waiting when determining that the first execution read-write set and the first signature are not received from the first node.

18. The non-transitory, computer-readable medium of claim 17, wherein the second node executes the first transaction when waiting timeout occurs or when verification on the first execution read set fails.

19. The non-transitory, computer-readable medium of claim 11, wherein:
a system contract is deployed in the blockchain, a contract state of the system contract stores the public key; and
comprising:
querying, by the second node, the contract state of the system contract to obtain the public key.

20. A computer-implemented system for blockchain transaction execution, comprising:
one or more computers; and
one or more computer memory devices interoperably coupled with the one or more computers and having tangible, non-transitory, machine-readable media storing one or more instructions that, when executed by the one or more computers, perform one or more operations, comprising:
executing, by a first node of a blockchain, a first transaction in a trusted execution environment (TEE) of the first node to obtain a first execution read-write set of the first transaction;
signing the first execution read-write set by using a private key stored in the TEE to obtain a first signature, wherein the first execution read-write set comprises a first execution read set and a first execution write set;
sending the first execution read-write set and the first signature to a second node of the blockchain;
verifying, by the second node, the first signature by using a public key corresponding to the private key;
verifying the first execution read set after the verification on the first signature succeeds; and
storing the first execution write set as an execution write set of the first transaction when the verification succeeds.
